(19) United States
(12) Patent Application Publication
(10) Pub. No.: US 2025/0316228 A1
(43) Pub. Date: Oct. 9, 2025

(54) DISPLAY DEVICE AND METHOD OF OPERATING A DISPLAY DEVICE

(71) Applicant: SAMSUNG DISPLAY CO., LTD., YONGIN-SI (KR)

(72) Inventors: GI-NA YOO, Yongin-si (KR); HYOMIN KIM, Yongin-si (KR); SIJIN SUNG, Yongin-si (KR)

(21) Appl. No.: 18/972,147

(22) Filed: Dec. 6, 2024

(30) Foreign Application Priority Data
Apr. 4, 2024 (KR) 10-2024-0046283

(51) Int. Cl. G09G 3/3233; G09G 3/20

(52) U.S. Cl. CPC G09G 3/3233; G09G 3/2007; G09G 2300/0819; G09G 2300/0842; G09G 2300/0852; G09G 2300/0861; G09G 2320/045; G09G 2330/021; G09G 2360/144

(57) ABSTRACT

A display device including: a display panel including a plurality of pixels; and a panel driver connected to the display panel, the panel driver configured to generate stress data representing a degradation amount of the display panel, to generate corrected image data by adjusting input image data based on the stress data, to determine a luminance of the display panel based on a display brightness value or the corrected image data, to adjust a second power supply voltage based on the stress data and the luminance of the display panel, and to drive the display panel based on the corrected image data, a first power supply voltage and the second power supply voltage.

### CROSS-REFERENCE TO RELATED APPLICATION(S)

This patent application claims priority under 35 U.S.C. § 119 to Korean Patent Application No. 10-2024-0046283, filed on Apr. 4, 2024, in the Korean Intellectual Property Office (KIPO), the disclosure of which is incorporated by reference herein in its entirety.

### 1. TECHNICAL FIELD

Embodiments of the present inventive concept relate to a display device, and more particularly to a display device that compensates for luminance reduction resulting from the degradation of a light emitting element, and a method of operating the display device.

### 2. DESCRIPTION OF THE RELATED ART

Over time, as display devices, such as organic light emitting diode (OLED) displays operate, light emitting elements (e.g., OLEDs) within their pixels may degrade. This degradation can lead to a reduction in pixel luminance, preventing the pixels from emitting light at a desired luminance. To compensate for this luminance decrease, the display device may generate stress data that represents degradation amounts of the pixels, and may adjust input image data based on the stress data.

### SUMMARY

Some embodiments of the present inventive concept provide a display device that can compensate for luminance reduction resulting from an increase in a driving voltage for a light emitting element.

Some embodiments of the present inventive concept provide a method for a display device to compensate for luminance reduction resulting from an increase in a driving voltage for a light emitting element.

According to an embodiment of the present inventive concept, there is provided a display device including: a display panel including a plurality of pixels; and a panel driver connected to the display panel, the panel driver configured to generate stress data representing a degradation amount of the display panel, to generate corrected image data by adjusting input image data based on the stress data, to determine a luminance of the display panel based on a display brightness value or the corrected image data, to adjust a second power supply voltage based on the stress data and the luminance of the display panel, and to drive the display panel based on the corrected image data, a first power supply voltage and the second power supply voltage.

The first power supply voltage is a high power supply voltage, the second power supply voltage is a low power supply voltage, and the panel driver decreases the low power supply voltage based on the stress data and the luminance of the display panel.

Each of the plurality of pixels includes a light emitting element, and the panel driver is configured to determine a driving voltage increment for the light emitting element based on the stress data and the luminance of the display panel, and to decrease the second power supply voltage by the driving voltage increment for the light emitting element.

The panel driver is configured to compensate for a luminance decrease of light emitting elements of the plurality of pixels by adjusting the input image data based on the stress data, or adjusting the second power supply voltage.

The panel driver includes: a scan driver configured to provide scan signals to the plurality of pixels; a data driver configured to provide data signals to the plurality of pixels based on the corrected image data; a power management circuit configured to provide the first power supply voltage and the second power supply voltage to the plurality of pixels; and a controller configured to control the scan driver, the data driver and the power management circuit, and to provide a power control signal to the power management circuit to adjust the second power supply voltage.

The controller includes: a degradation accumulating circuit configured to generate the stress data based on the corrected image data; a degradation compensating circuit configured to generate the corrected image data by adjusting the input image data based on the stress data; an output image analyzing circuit configured to determine the luminance of the display panel based on the display brightness value and the corrected image data; and a driving voltage determining circuit configured to determine a voltage level of the second power supply voltage based on the stress data and the luminance of the display panel, and to provide the power control signal, which represents the determined voltage level of the second power supply voltage, to the power management circuit.

The degradation accumulating circuit generates the stress data by accumulating the corrected image data.

When the stress data indicates a first degradation amount for a first pixel among the plurality of pixels, and indicates a second degradation amount, which is greater than the first degradation amount, for a second pixel among the plurality of pixels, the degradation compensating circuit generates the corrected image data by increasing a gray level of the input image data for the second pixel.

When the stress data indicates a first degradation amount for a first pixel among the plurality of pixels, and indicates a second degradation amount, which is greater than the first degradation amount, for a second pixel among the plurality of pixels, the degradation compensating circuit generates the corrected image data by decreasing a gray level of the input image data for the first pixel.

The luminance of the display panel determined by the output image analyzing circuit increases as the display brightness value increases, and increases as a gray level indicated by the corrected image data increases.

The output image analyzing circuit includes: a luminance lookup table configured to store luminance values corresponding to gray levels indicated by the corrected image data for each of a plurality of display brightness values, and the output image analyzing circuit determines luminances of the plurality of pixels by using the luminance lookup table, and selects, a maximum luminance of the plurality of pixels as the luminance of the display panel.

The output image analyzing circuit includes: a luminance lookup table configured to store luminance values corresponding to gray levels indicated by the corrected image data for each of a plurality of display brightness values, and the output image analyzing circuit determines luminances of the plurality of pixels by using the luminance lookup table, and selects, an average luminance of the plurality of pixels as the luminance of the display panel.

The voltage level of the second power supply voltage determined by the driving voltage determining circuit decreases as the degradation amount indicated by the stress data increases, and decreases as the luminance of the display panel increases.

The driving voltage determining circuit includes: a driving voltage lookup table configured to store a plurality of driving voltage increments corresponding to a plurality of degradation amounts and a plurality of luminances, and the driving voltage determining circuit determines a driving voltage increment corresponding to the stress data and the luminance of the display panel by using the driving voltage lookup table, and sets the voltage level of the second power supply voltage based on the determined driving voltage increment.

When the determined driving voltage increment is less than or equal to a reference voltage increment corresponding to the luminance of the display panel, the driving voltage determining circuit sets the voltage level of the second power supply voltage to a default voltage level, and when the determined driving voltage increment is greater than the reference voltage increment, the driving voltage determining circuit decreases the voltage level of the second power supply voltage by the determined driving voltage increment.

The display device further includes a photo sensor configured to detect external ultraviolet light, wherein the panel driver accumulates an exposure time during which the display panel is exposed to the external ultraviolet light by using the photo sensor, and further adjusts the second power supply voltage based on the exposure time.

The panel driver decreases the second power supply voltage as the exposure time increases.

The plurality of pixels includes red pixels, green pixels and blue pixels, wherein the second power supply voltage includes a second red power supply voltage to be applied to the red pixels, a second green power supply voltage to be applied to the green pixels, and a second blue power supply voltage to be applied to the blue pixels, and the panel driver adjusts the second red power supply voltage based on stress data for the red pixels and a luminance of the red pixels, adjusts the second green power supply voltage based on stress data for the green pixels and a luminance of the green pixels, and adjusts the second blue power supply voltage based on stress data for the blue pixels and a luminance of the blue pixels.

According to an embodiment of the present inventive concept, there is provided a method of operating a display device, the method including: generating stress data that represents a degradation amount for a display panel of the display device; generating corrected image data by adjusting input image data based on the stress data; determining a luminance of the display panel based on a display brightness value or the corrected image data; adjusting a second power supply voltage based on the stress data and the luminance of the display panel; and driving the display panel based on the corrected image data, a first power supply voltage and the second power supply voltage.

Adjusting the second power supply voltage includes: determining a driving voltage increment for a light emitting element based on the stress data and the luminance of the display panel; and decreasing the second power supply voltage by the driving voltage increment for the light emitting element.

As described above, in a display device and a method of operating the display device according to embodiments of the present inventive concept, corrected image data may be generated by correcting input image data based on stress data, and a display panel may be driven using the corrected image data. This allows for compensation of luminance reduction caused by the degradation of the light-emitting element.

Further, in the display device and the method of operating the display device according to embodiments of the present inventive concept, a luminance of the display panel may be determined based on a display brightness value or the corrected image data, and a second power supply voltage (e.g., a low power supply voltage) may be adjusted based on the stress data and the luminance of the display panel. Accordingly, the power consumption of the display device may be reduced, and the luminance reduction caused by an increase in a driving voltage for the light emitting element may be compensated.

### BRIEF DESCRIPTION OF THE DRAWINGS

Illustrative, non-limiting embodiments of the present inventive concept will be more clearly understood from the following detailed description taken in conjunction with the accompanying drawings.

FIG. 1 is a block diagram illustrating a display device according to embodiments.

FIGS. 2A, 2B and 2C are circuit diagrams illustrating examples of a pixel included in a display device according to embodiments.

FIG. 3 is a block diagram illustrating a controller of a display device according to embodiments.

FIG. 4 is a diagram illustrating an example of luminance according to a degradation amount.

FIG. 5 is a diagram illustrating a portion of a pixel to which a first power supply voltage and a second power supply voltage are applied.

FIG. 6 is a diagram illustrating an example of luminances of display panels having different degradation amounts according to a second power supply voltage.

FIG. 7 is a diagram for describing an example of determining voltage levels of a second power supply voltage with respect to display panels having different degradation amounts in a display device according to embodiments.

FIGS. 8A and 8B are diagrams illustrating an example of a driving voltage increment according to luminance and a degradation amount of a display panel.

FIGS. 9A and 9B are diagrams illustrating an example of a second power supply voltage that is determined according to luminance and a degradation amount of a display panel in a display device according to embodiments.

FIGS. 10A and 10B are diagrams illustrating another example of a second power supply voltage that is determined according to luminance and a degradation amount of a display panel in a display device according to embodiments.

FIG. 11 is a flowchart illustrating a method of operating a display device according to embodiments.

FIG. 12 is a block diagram illustrating a display device according to embodiments.

FIG. 13 is a diagram illustrating an example of a second power supply voltage according to an exposure time of external ultraviolet light.

FIG. 14 is a block diagram illustrating a display device according to embodiments.

FIG. 15 is a diagram for describing an example of a second red power supply voltage, a second green power supply voltage and a second blue power supply voltage.

FIG. 16 is a block diagram illustrating an electronic device including a display device according to embodiments.

### DETAILED DESCRIPTION OF THE EMBODIMENTS

Hereinafter, embodiments of the present inventive concept will be explained in detail with reference to the accompanying drawings.

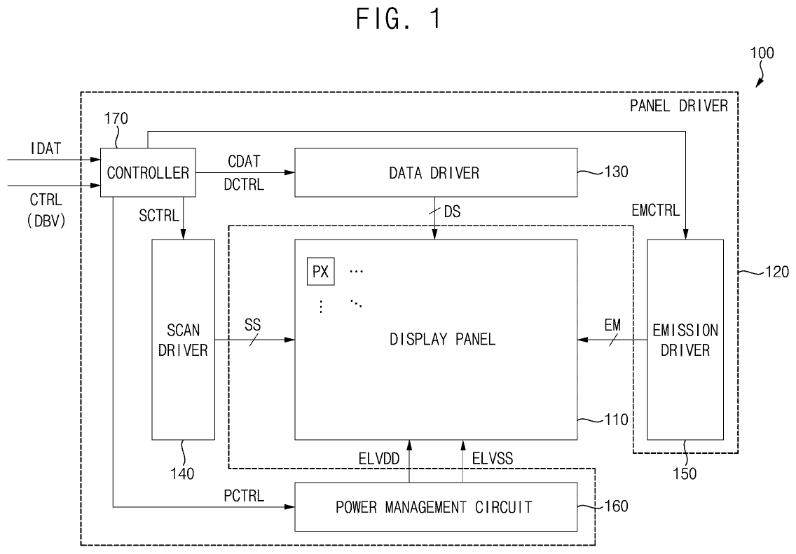

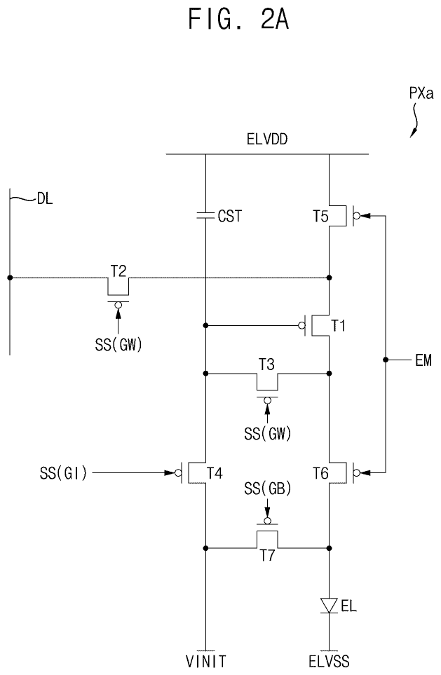

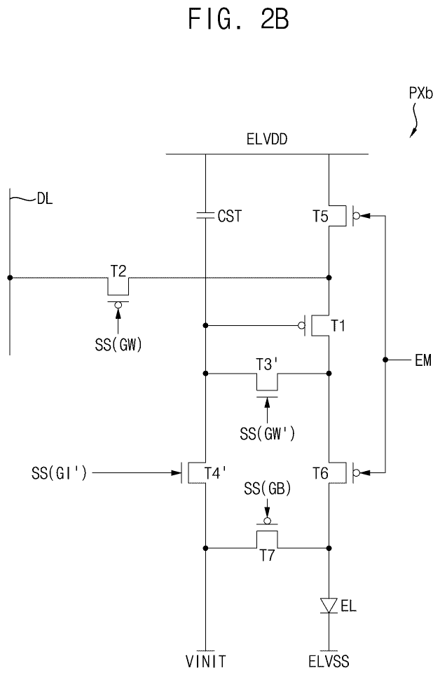

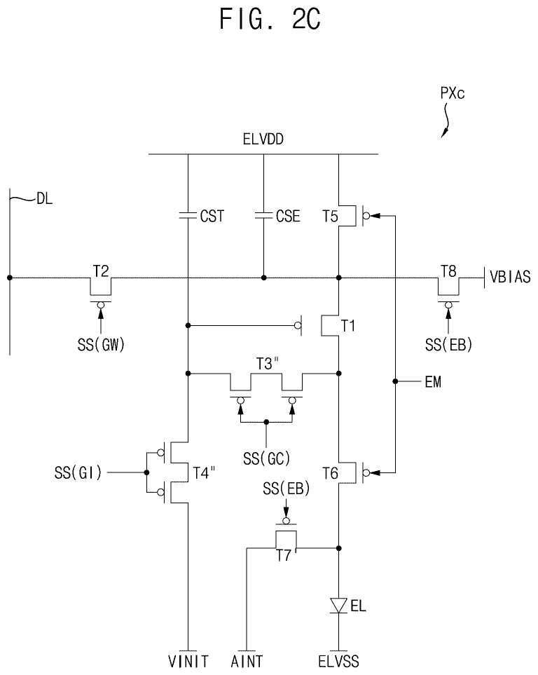

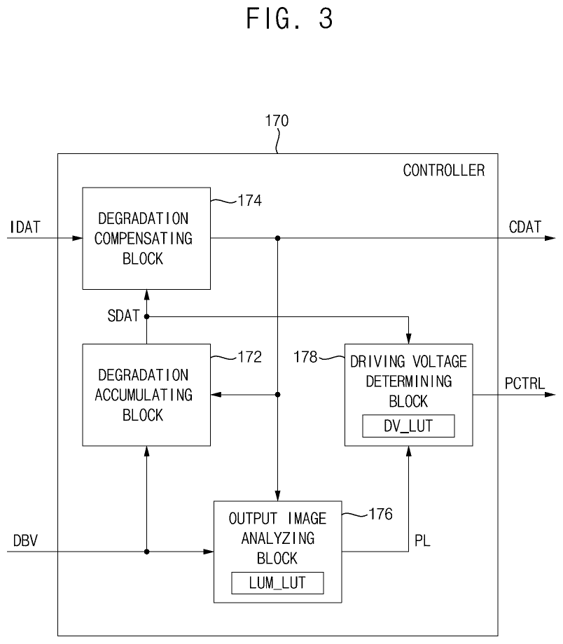

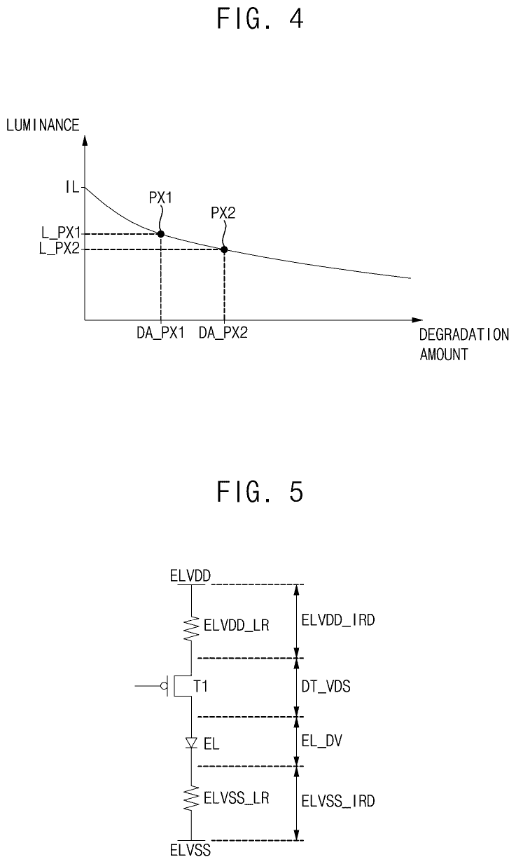

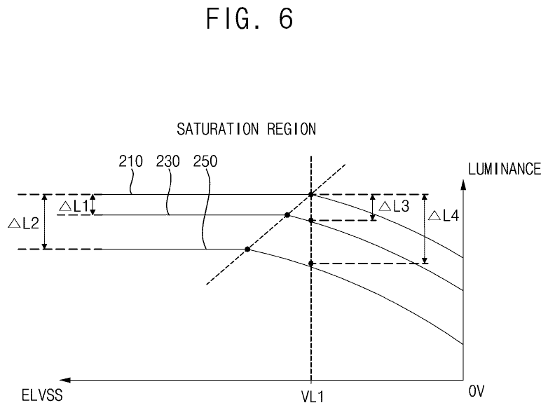

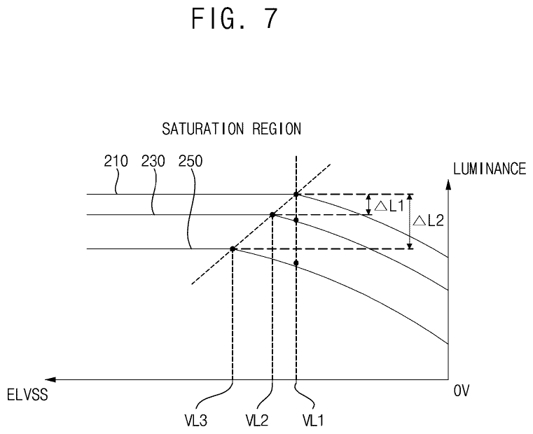

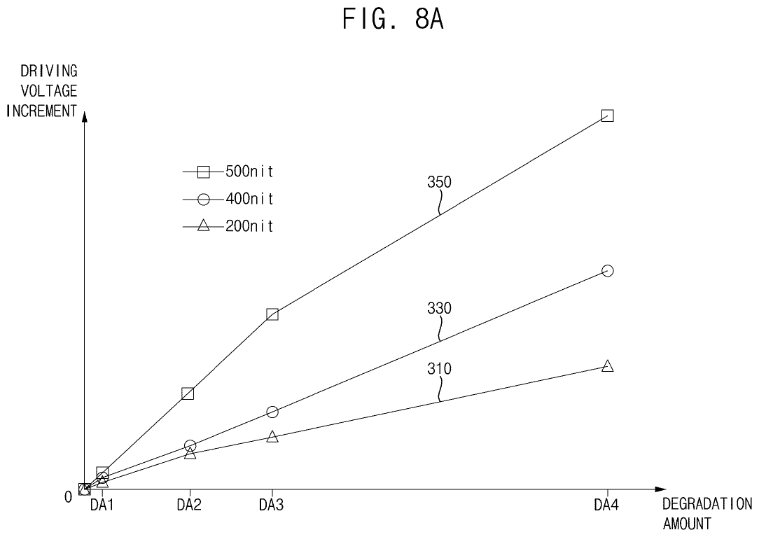

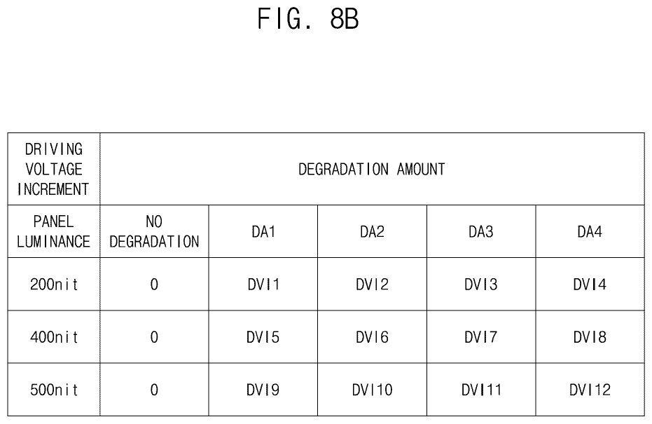

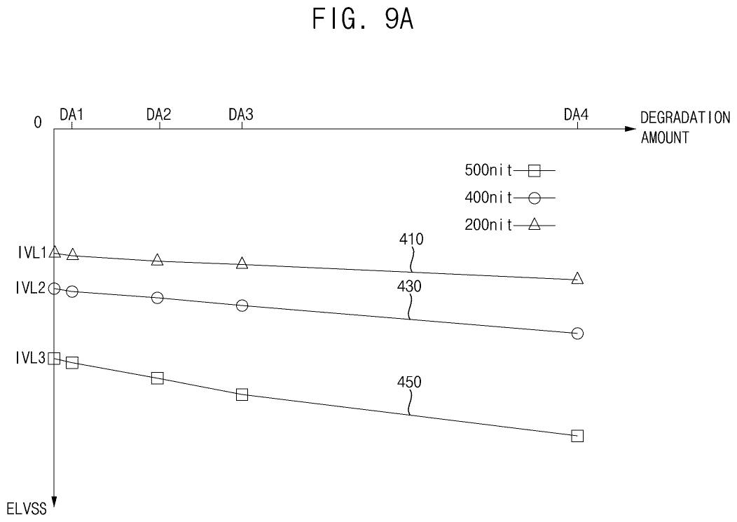

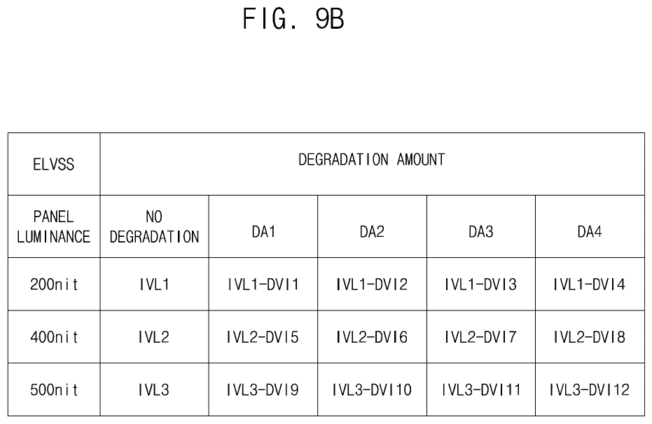

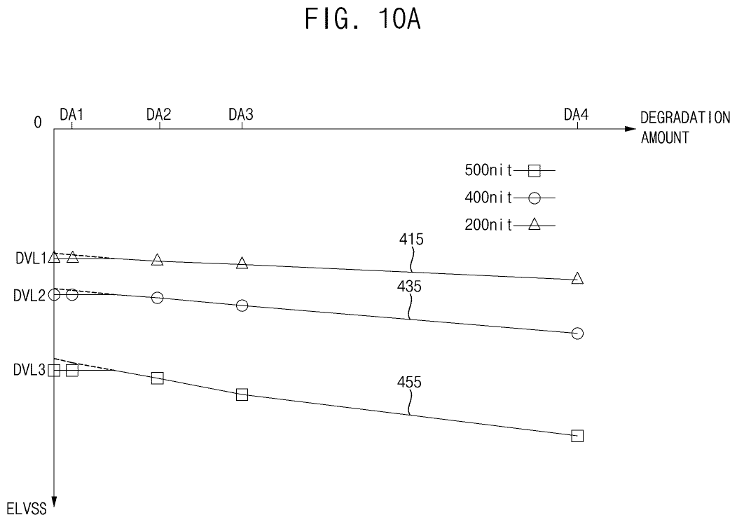

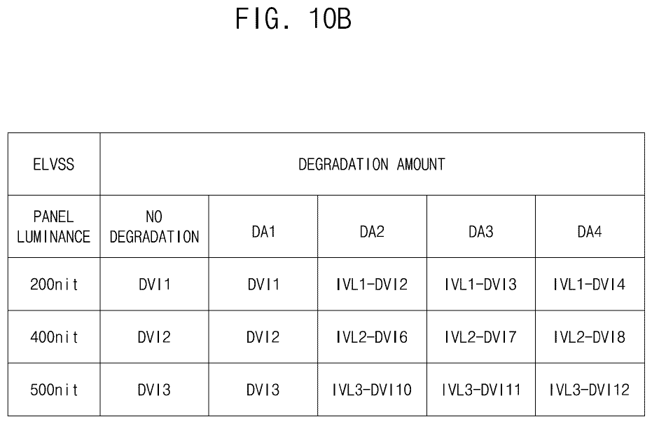

FIG. 1 is a block diagram illustrating a display device according to embodiments, FIGS. 2A, 2B and 2C are circuit diagrams illustrating examples of a pixel included in a display device according to embodiments, FIG. 3 is a block diagram illustrating a controller of a display device according to embodiments, FIG. 4 is a diagram illustrating an example of luminance according to a degradation amount, FIG. 5 is a diagram illustrating a portion of a pixel to which a first power supply voltage and a second power supply voltage are applied, FIG. 6 is a diagram illustrating an example of luminances of display panels having different degradation amounts according to a second power supply voltage, FIG. 7 is a diagram for describing an example of determining voltage levels of a second power supply voltage with respect to display panels having different degradation amounts in a display device according to embodiments, FIGS. 8A and 8B are diagrams illustrating an example of a driving voltage increment according to luminance and a degradation amount of a display panel, FIGS. 9A and 9B are diagrams illustrating an example of a second power supply voltage that is determined according to luminance and a degradation amount of a display panel in a display device according to embodiments, and FIGS. 10A and 10B are diagrams illustrating another example of a second power supply voltage that is determined according to luminance and a degradation amount of a display panel in a display device according to embodiments.

Referring to FIG. 1, a display device 100 according to embodiments may include a display panel 110 that includes a plurality of pixels PX, and a panel driver 120 that is connected to and drives the display panel 110. In some embodiments, the panel driver 120 may include a data driver 130 that provides data signals DS to the plurality of pixels PX, a scan driver 140 that provides scan signals SS to the plurality of pixels PX, an emission driver 150 that provides emission signals EM to the plurality of pixels PX, a power management circuit 160 that provides a first power supply voltage ELVDD and a second power supply voltage ELVSS to the display panel 110, and a controller 170 that controls the data driver 130, the scan driver 140, the emission driver 150 and the power management circuit 160.

The display panel 110 may include a plurality of data lines, a plurality of scan lines, a plurality of emission lines, and the plurality of pixels PX connected thereto. In some embodiments, as illustrated in FIG. 2A, each pixel PXa may include a storage capacitor CST, first, second, third, fourth, fifth, sixth and seventh transistors T1, T2, T3, T4, T5, T6 and T7, and a light emitting element EL.

The storage capacitor CST may store the data signal DS transferred through the second transistor T2 and the first transistor T1 that is diode-connected by the third transistor T3. In some embodiments, the storage capacitor CST may include a first electrode connected to a line which transfers the first power supply voltage ELVDD (e.g., a high power supply voltage), and a second electrode connected to a gate of the first transistor T1.

The first transistor T1 may generate a driving current based on the data signal DS stored in the storage capacitor CST. In some embodiments, the first transistor T1 may include the gate connected to the storage capacitor CST, a first terminal connected to the second and fifth transistors T2 and T5, and a second terminal connected to the third and sixth transistors T3 and T6.

The second transistor T2 may transfer the data signal DS from the data line DL to the first terminal of the first transistor T1 in response to the scan signal SS (or a write signal GW). In some embodiments, the second transistor T2 may include a gate which receives the scan signal SS (or the write signal GW), a first terminal connected to the data line DL, and a second terminal connected to the first terminal of the first transistor T1.

The third transistor T3 may diode-connect the first transistor T1 in response to the scan signal SS (or the write signal GW). In some embodiments, the third transistor T3 may include a gate which receives the scan signal SS (or the write signal GW), a first terminal connected to the second terminal of the first transistor T1, and a second terminal connected to the gate of the first transistor T1.

The fourth transistor T4 may apply an initialization voltage VINIT to the storage capacitor CST and the gate of the first transistor T1 in response to the scan signal SS (or an initialization signal GI). In some embodiments, the fourth transistor T4 may include a gate which receives the scan signal SS (or the initialization signal GI), a first terminal connected to the storage capacitor CST and the gate of the first transistor T1, and a second terminal connected to a line which transfers the initialization voltage VINIT.

The fifth and sixth transistors T5 and T6 may form a path for the driving current from the line which transfers the first power supply voltage ELVDD to a line which transfers the second power supply voltage ELVSS (e.g., a low power supply voltage) in response to the emission signal EM. In some embodiments, the fifth transistor T5 may include a gate which receives the emission signal EM, a first terminal connected to the line which transfers the first power supply voltage ELVDD, and a second terminal connected to the first terminal of the first transistor T1. The sixth transistor T6 may include a gate which receives the emission signal EM, a first terminal connected to the second terminal of the first transistor T1, and a second terminal connected to an anode of the light emitting element EL.

The seventh transistor T7 may apply the initialization voltage VINIT to the anode of the light emitting element EL in response to the scan signal SS (or a bypass signal GB). In some embodiments, the seventh transistor T7 may include a gate which receives the scan signal SS (or the bypass signal GB), a first terminal connected to the anode of the light emitting element EL, and a second terminal connected to the line which transfers the initialization voltage VINIT.

The light emitting element EL may emit light based on the driving current generated by the first transistor T1. In some embodiments, the light emitting element EL may be an organic light emitting diode (OLED), but is not limited thereto. In other embodiments, the light emitting element EL may be any suitable light emitting element. For example, the light emitting element EL may be a micro light emitting diode, a nano light emitting diode (NED), a quantum dot (QD) light emitting diode, an inorganic light emitting diode, or any other suitable light emitting element. In some embodiments, the light emitting element EL may include the anode connected to the sixth and seventh transistors T6 and T7, and a cathode connected to the line which transfers the second power supply voltage ELVSS.

Although FIG. 2A illustrates an example in which the scan signals SS applied to the second and third transistors T2 and T3 are the same write signal GW, in other embodiments, the scan signals SS applied to the second and third transistors T2 and T3 may be different. In some embodiments, as illustrated in FIG. 2A, the first through seventh transistors T1 through T7 may be implemented as P-type metal oxide semiconductor (PMOS) transistors, but are not limited thereto.

In other embodiments, as illustrated in FIG. 2B, each pixel PXb may include the storage capacitor CST, the first transistor T1, the second transistor T2, a third transistor T3′, a fourth transistor T4′, the fifth transistor T5, the sixth transistor T6, the seventh transistor T7 and the light emitting element EL. In this embodiment, at least one of the first through seventh transistors T1, T2, T3′, T4′, T5, T6 and T7 may be implemented as an N-type metal oxide semiconductor (NMOS) transistor. For example, as illustrated in FIG. 2B, the first transistor T1, the second transistor T2, the fifth transistor T5, the sixth transistor T6 and the seventh transistor T7 may be PMOS transistors, and the third transistor T3′ and the fourth transistor T4′ may be NMOS transistors. In this case, leakage current through the third and fourth transistors T3′ and T4′ may be reduced. Further, the third transistor T3′ may receive an inverted write signal GW′ that is inverted with respect to the write signal GW as the scan signal SS, and the fourth transistor T4′ may receive an inverted initialization signal GI′ that is inverted with respect to the initialization signal GI as the scan signal SS, but are not limited thereto.

In other embodiments, as illustrated in FIG. 2C, each pixel PXc may include the storage capacitor CST, a hold capacitor CSE, the first transistor T1, the second transistor T2, a third transistor T3″, a fourth transistor T4″, the fifth transistor T5, the sixth transistor T6, a seventh transistor T7′, an eighth transistor T8 and the light emitting element EL. The pixel PXc of FIG. 2C may have a similar configuration and a similar operation to the pixel PXa of FIG. 2A, except that the pixel PXc may further include the hold capacitor CSE and the eighth transistor T8.

The hold capacitor CSE may hold a voltage of the first terminal of the first transistor T1. In other words, hold capacitor CSE may maintain the voltage at the first terminal of the first transistor T1. In some embodiments, the hold capacitor CSE may include a first electrode connected to the line which transfers the first power supply voltage ELVDD, and a second electrode connected to the first terminal of the first transistor T1.

Each of the third transistor T3″ and the fourth transistor T4″ may be implemented as a dual transistor including two sub-transistors connected in series. In this case, the leakage current through the third and fourth transistors T3″ and T4″ may be reduced. Further, the third transistor

T3″ may receive a compensation signal GC different from the write signal GW as the scan signal SS, but is not limited thereto.

The seventh transistor T7′ may apply an anode initialization voltage AINT to the anode of the light emitting element EL in response to the scan signal SS (or an inverted emission signal EB). According to embodiments, the anode initialization voltage AINT may be the same as the initialization voltage VINIT, or may be a different from the initialization voltage VINIT. In some embodiments, the seventh transistor T7′ may include a gate which receives the scan signal SS (or the inverted emission signal EB), a first terminal connected to the anode of the light emitting element EL, and a second terminal connected to a line which transfers the anode initialization voltage AINT.

The eighth transistor T8 may apply a bias voltage VBIAS to the first terminal of the first transistor T1 in response to the scan signal SS (or the inverted emission signal EB). The hysteresis of the first transistor T1 may be reset based on the bias voltage VBIAS. In some embodiments, the eighth transistor T8 may include a gate which receives the scan signal SS (or the inverted emission signal EB), a first terminal connected to the first terminal of the first transistor T1, and a second terminal connected to a line which transfers the bias voltage VBIAS.

Although FIGS. 2A, 2B and 2C illustrate an example of the pixel PXa having a 7T1C structure, an example of the pixel PXb having a 7T1C structure and an example of the pixel PXc having an 8T2C structure, a structure of the pixel PX of the display device 100 according to embodiments is not limited to the examples illustrated in FIGS. 2A, 2B and 2C.

The data driver 130 may generate the data signals DS based on corrected image data CDAT and a data control signal DCTRL received from the controller 170, and may provide the data signals DS to the plurality of pixels PX through the plurality of data lines DL. In some embodiments, the data control signal DCTRL may include, but is not limited to, an output data enable signal, a horizontal start signal, and a load signal. Further, in some embodiments, the data driver 130 and the controller 170 may be implemented as a single integrated circuit, and the single integrated circuit may be referred to as a timing controller embedded data driver (TED) integrated circuit. In other embodiments, the data driver 130 and the controller 170 may be implemented as separate integrated circuits.

The scan driver 140 may generate the scan signals SS based on a scan control signal SCTRL received from the controller 170, and may sequentially provide the scan signals SS to the plurality of pixels PX through the plurality of scan lines on a row-by-row basis. In some embodiments, the scan control signal SCTRL may include, but is not limited to, a scan start signal and a scan clock signal. In some embodiments, the scan signals SS applied to each pixel PX may include, but are not limited to, the write signal GW, the initialization signal GI, and/or the bypass signal GB illustrated in FIGS. 2A, 2B and 2C. Further, in some embodiments, the scan driver 140 may be integrated or formed in the display panel 110. In other embodiments, the scan driver 140 may be implemented as one or more integrated circuits.

The emission driver 150 may generate the emission signals EM based on an emission control signal EMCTRL received from the controller 170, and may sequentially provide the emission signals EM to the plurality of pixels PX through the plurality of emission lines on a row-by-row basis. In some embodiments, the emission control signal EMCTRL may include, but is not limited to, an emission start signal and an emission clock signal. Further, in some embodiments, the emission driver 150 may be integrated or formed in the display panel 110. In other embodiments, the emission driver 150 may be implemented as one or more integrated circuits.

The power management circuit 160 may generate the first and second power supply voltages ELVDD and ELVSS required for an operation of the display device 100 based on a power control signal PCTRL received from the controller 170. For example, the power management circuit 160 may generate the first power supply voltage ELVDD and the second power supply voltage ELVSS provided to the plurality of pixels PX of the display panel 110. In some embodiments, the power management circuit 160 may generate the first power supply voltage ELVDD having a substantially constant voltage level, and may change a voltage level of the second power supply voltage ELVSS in response to the power control signal PCTRL. Further, in some embodiments, the power management circuit 160 may be implemented as an integrated circuit, and the integrated circuit can be referred to as a power management integrated circuit (PMIC). In other embodiments, the power management circuit 160 may be included in the data driver 130 or the controller 170.

The controller 170 (e.g., a timing controller) may receive input image data IDAT and a control signal CTRL from an external host processor (e.g., an application processor (AP), a graphics processing unit (GPU), a graphics card, etc.). In some embodiments, the control signal CTRL may include a display brightness value DBV (or a dimming level) that represents the luminance of the display panel 110 corresponding to the maximum gray level (e.g., a 255-gray level). The panel driver 120 may adjust the luminance of the display panel 110 in response to the display brightness value DBV (or the dimming level). In some embodiments, the control signal CTRL may further include, but is not limited to, a vertical synchronization signal, a horizontal synchronization signal, an input data enable signal, a master clock signal, etc. The controller 170 may generate the corrected image data CDAT, the data control signal DCTRL, the scan control signal SCTRL, the emission control signal EMCTRL and the power control signal PCTRL based on the input image data IDAT and the control signal CTRL. The controller 170 may control the data driver 130 by providing the corrected image data CDAT and the data control signal DCTRL to the data driver 130, may control the scan driver 140 by providing the scan control signal SCTRL to the scan driver 140, may control the emission driver 150 by providing the emission control signal EMCTRL to the emission driver 150, and may control the power management circuit 160 by providing the power control signal PCTRL to the power management circuit 160.

In the display device 100 according to embodiments, the panel driver 120 may generate stress data representing a degradation amount of the display panel 110, generate the corrected image data CDAT by correcting the input image data IDAT based on the stress data, determine a luminance of the display panel 110 based on the display brightness value DBV or the corrected image data CDAT, adjust the second power supply voltage ELVSS based on the stress data and the luminance of the display panel 110, and drive the display panel 110 using the corrected image data CDAT, the first power supply voltage ELVDD and the adjusted second power supply voltage ELVSS. In some embodiments, the first power supply voltage ELVDD may be the high power supply voltage, the second power supply voltage ELVSS may be the low power supply voltage, and the panel driver 120 may reduce the second power supply voltage ELVSS based on the stress data and the luminance of the display panel 110. For example, the panel driver 120 may determine a driving voltage increment for the light emitting element EL based on the stress data and the luminance of the display panel 110, and may reduce the second power supply voltage ELVSS by the driving voltage increment. Accordingly, in the display device 100 according to embodiments, the panel driver 120 not only may compensate for a luminance decrease of the light emitting elements EL caused by their degradation by correcting the input image data IDAT based on the stress data, but also may compensate for a luminance decrease of the light emitting elements EL caused by an increased driving voltage for the light emitting elements EL by adjusting the second power supply voltage ELVSS.

To perform these operations, as illustrated in FIG. 3, the controller 170 of the panel driver 120 may include a degradation accumulating block 172 (or a degradation accumulating circuit), a degradation compensating block 174 (or a degradation compensating circuit), an output image analyzing block 176 (or an output image analyzing circuit) and a driving voltage determining block 178 (or a driving voltage determining circuit).

The degradation accumulating block 172 may generate the stress data SDAT that represents the degradation amount for the display panel 110 based on the corrected image data CDAT. For example, the degradation accumulating block 172 may generate the stress data SDAT, representing degradation amounts for the light emitting elements EL of the plurality of pixels PX in the display panel 110, by accumulating the corrected image data CDAT for the plurality of pixels PX. In this case, the corrected image data CDAT may be input to the degradation accumulating block 172 and the stress data SDAT may be output from the degradation accumulating block 172. In some embodiments, the degradation accumulating block 172 may receive the display brightness value DBV, and generate the stress data SDAT by accumulating the corrected image data CDAT while taking into account or reflecting the display brightness value DBV. For example, the degradation accumulating block 172 may increase a value of the corrected image data CDAT added to the stress data SDAT as the luminance of the display panel 110, indicated by the display brightness value DBV, increases. Further, in some embodiments, the degradation accumulating block 172 may receive temperature information of the display panel 110, and generate the stress data SDAT by accumulating the corrected image data CDAT while taking into account or reflecting the temperature information. For example, the degradation accumulating block 172 may increase the value of the corrected image data CDAT added to the stress data SDAT as a temperature of the display panel 110, indicated by the temperature information, increases.

The degradation compensating block 174 may generate the corrected image data CDAT by correcting the input image data IDAT based on the stress data SDAT. For example, as illustrated in FIG. 4, the luminance of the display panel 110 or the luminance of each pixel PX of the display panel 110 may gradually decrease from an initial luminance IL as the degradation amount of the light emitting element EL of each pixel PX increases. The degradation compensating block 174 may generate the corrected image data CDAT for the pixel PX by correcting the input image data IDAT for the pixel PX based on the stress data SDAT indicating the degradation amount of the light emitting element EL of each pixel PX. In other words, the degradation compensating block 174 may generate the corrected image data CDAT for the pixel PX by adjusting the input image data IDAT for the pixel PX based on the stress data SDAT, which indicates the degradation amount of the light emitting element EL for each pixel PX. In some embodiments, as illustrated in FIG. 4, when the stress data SDAT indicates a first degradation amount DA_PX1 for a first pixel PX1 and a second degradation amount DA_PX2, which is greater than the first degradation amount DA_PX1, for a second pixel PX2, the degradation compensating block 174 may generate the corrected image data CDAT by increasing a gray level of the input image data IDAT for the second pixel with the relatively greater second degradation amount DA_PX2. In other embodiments, the degradation compensating block 174 may generate the corrected image data CDAT by decreasing a gray level of the input image data IDAT for the first pixel PX1 with the relatively smaller first degradation amount DA_PX1.

In this manner, in the display device 100 according to embodiments, the degradation compensating block 174 may generate the corrected image data CDAT by compensating the input image data IDAT based on the stress data SDAT generated by the degradation accumulating block 172, and the data driver 130 may provide the data signals DS to the plurality of pixels PX based on the corrected image data CDAT. As a result, since the input image data IDAT is corrected based on the stress data SDAT that reflects the degradation amount of each pixel's PX light emitting element EL, the luminance reduction caused by the degradation of the light emitting element EL in each pixel PX may be compensated. However, while the luminance decrease caused by the degradation of the light emitting element EL is compensated, the reduction in luminance due to an increase in the driving voltage for the light emitting element EL may not be compensated. To resolve this, the display device 100 according to embodiments may compensate for the luminance decrease caused by an increased driving voltage by reducing the second power supply voltage ELVSS as the driving voltage of the light emitting element EL increases.

For example, as illustrated in FIG. 5, the first power supply voltage ELVDD and the second power supply voltage ELVSS applied to each pixel PX may be set such that a voltage difference between the first power supply voltage ELVDD and the second power supply voltage ELVSS is greater than or equal to a sum of a voltage drop ELVDD_IRD of the first power supply voltage ELVDD due to a resistance ELVDD_LR of the line which transfers the first power supply voltage ELVDD, a drain-source voltage DT_VDS of the first transistor T1 (or a driving transistor), the driving voltage EL_DV for the light emitting element EL, and a voltage drop ELVSS_IRD of the second power supply voltage ELVSS due to a resistance ELVSS_LR of the line which transfers the second power supply voltage ELVSS. In this context, the driving voltage EL_DV for the light emitting element EL refers to the voltage applied to the light emitting element EL to achieve a desired luminance. The driving voltage EL_DV may increase as the light emitting element EL degrades, or as the luminance of the light emitting element EL rises. In a conventional display device, even if the driving voltage EL_DV increases, both the first power supply voltage ELVDD and the second power supply voltage ELVSS remain at fixed levels. However, in the display device 100 according to embodiments, as the driving voltage EL_DV for the light emitting element EL increases, the voltage level of the second power supply voltage ELVSS may decrease, thereby compensating for the luminance reduction caused by the increase in the driving voltage EL_DV.

In FIGS. 6 and 7, 210 represents the luminance of the display panel 110 according to the second power supply voltage ELVSS before the light emitting element EL is degraded or when the light emitting element EL is not degraded, 230 represents the luminance of the display panel 110 according to the second power supply voltage ELVSS after the light emitting element EL is degraded by a first degradation amount, and 250 represents the luminance of the display panel 110 according to the second power supply voltage ELVSS after the light emitting element EL is degraded by a second degradation amount greater than the first degradation amount. As illustrated in FIGS. 6 and 7, if the second power supply voltage ELVSS has an excessively low voltage level (or a voltage level lower than a third voltage level VL3) in a saturation region, the luminance 230 of the display panel 110 in which the light emitting element EL is degraded by the first degradation amount may be lower by a first luminance difference ΔL1 than the luminance 210 of the display panel 110 in which the light emitting element EL is not degraded, and the luminance 250 of the display panel 110 in which the light emitting element EL is degraded by the second degradation amount may be lower by a second luminance difference ΔL2 than the luminance 210 of the display panel 110 in which the light emitting element EL is not degraded. The luminance decrease caused by the degradation of the light emitting element EL may be compensated by correcting the input image data IDAT based on the stress data SDAT. However, in this case, because the second power supply voltage ELVSS has an excessively low voltage level, the power consumption of the display device 100 may significantly increase. In a conventional display device, as illustrated in FIG. 6, the second power supply voltage ELVSS may be set to a first voltage level VL1, which is appropriate for the display panel 110 where the light emitting element EL has not degraded or where the luminance 210 of the display panel 110 starts to decrease. However, in this conventional display device, since the second power supply voltage ELVSS remains fixed at the first voltage level VL1, the luminance 230 of the display panel 110 with the light emitting element EL degraded by the first degradation amount may decrease by a third luminance difference ΔL3, which is greater than the first luminance difference ΔL1 from the luminance 210 of the display panel 110 without degradation. As a result, the luminance decrease may not be fully compensated, even if the input image data IDAT is corrected based on the stress data SDAT.

Further, in the conventional display device, the luminance 250 of the display panel 110 where the light emitting element EL is degraded by the second degradation amount may decrease by a fourth luminance difference ΔL4, which is greater than the second luminance difference ΔL2 from the luminance 210 of the display panel 110 which is not degraded. Again, the luminance decrease may not be adequately compensated, even if the input image data IDAT is corrected based on the stress data SDAT. In other words, in the conventional display device, the luminance decrease caused by the increase in the driving voltage EL_DV for the light emitting element EL cannot be fully compensated.

However, in the display device 100 according to embodiments, as illustrated in FIG. 7, when the light emitting element EL is degraded by the first degradation amount, the second power supply voltage ELVSS may be reduced from the first voltage level VL1 to a second voltage level VL2, such that the luminance 230 of the display panel 110, where the light emitting element EL is degraded by the first degradation amount, is lower by the first luminance difference ΔL1 compared to the luminance 210 of the display panel 110 where the light emitting element EL is not degraded. Further, when the light emitting element EL is degraded by the second degradation amount, the second power supply voltage ELVSS may be further reduced to the third voltage level VL3, such that the luminance 250 of the display panel 110, where the light emitting element EL is degraded by the second degradation amount, is lower by the second luminance difference ΔL2 from the luminance 210 of the display panel 110 with no degradation.

Accordingly, in the display device 100 according to embodiments, the luminance decrease caused by the degradation of the light emitting element EL may be compensated by correcting the input image data IDAT based on the stress data SDAT. Additionally, the luminance reduction caused by the increase in the driving voltage EL_DV for the light emitting element EL may be compensated by reducing the second power supply voltage ELVSS.

To compensate for the luminance decrease of the light emitting element EL caused by the increase in the driving voltage EL_DV for the light emitting element EL, the output image analyzing block 176 may determine the luminance PL of the display panel 110 based on the display brightness value DBV and the corrected image data CDAT. For example, the luminance PL of the display panel 110, as determined by the output image analyzing block 176, may increase as the display brightness value DBV increases, and it may also increase as a gray level indicated by the corrected image data CDAT increases. In some embodiments, the output image analyzing block 176 may include a luminance lookup table LUM_LUT that stores luminances (e.g., luminance values) corresponding to gray levels indicated by the corrected image data CDAT for each of a plurality of display brightness values DBV. The output image analyzing block 176 may determine the luminances of the plurality of pixels PX by using the luminance lookup table LUM_LUT, and may determine the maximum luminance among the luminances of the plurality of pixels PX as the luminance PL of the display panel 110. In other embodiments, the output image analyzing block 176 may use the luminance lookup table LUM_LUT to determine the luminances of the plurality of pixels PX and calculate an average luminance of these pixels as the luminance PL of the display panel 110.

Further, the driving voltage determining block 178 may determine the voltage level of the second power supply voltage ELVSS based on the stress data SDAT and the luminance PL of the display panel 110. The driving voltage determining block 178 may then provide the power control signal PCTRL to the power management circuit 160, wherein the power control signal PCTRL indicates the determined voltage level of the second power supply voltage ELVSS. For example, the voltage level of the second power supply voltage ELVSS determined by the driving voltage determining block 178 may decrease as the degradation amount indicated by the stress data SDAT increases, and may also decrease as the luminance PL of the display panel 110 increases.

In some embodiments, the driving voltage determining block 178 may include a driving voltage lookup table DV_LUT that stores a plurality of driving voltage increments corresponding to a plurality of degradation amounts and a plurality of luminances. The driving voltage determining block 178 may use the driving voltage lookup table DV_LUT to determine a driving voltage increment corresponding to the stress data SDAT and the luminance PL of the display panel 110, and subsequently determine the voltage level of the second power supply voltage

ELVSS based on the determined driving voltage increment.

In FIG. 8A, 310 represents the driving voltage increment for the light emitting element EL according to degradation amounts DA1, DA2, DA3 and DA4 of the display panel 110 (or the light emitting element EL) when the luminance PL of the display panel 110 is about 200 nit, 330 represents the driving voltage increment for the light emitting element EL according to the degradation amounts DA1, DA2, DA3 and DA4 of the display panel 110 when the luminance PL of the display panel 110 is about 400 nit, and 350 represents the driving voltage increment for the light emitting element EL according to the degradation amounts DA1, DA2, DA3 and DA4 of the display panel 110 when the luminance PL of the display panel 110 is about 500 nit. As illustrated in FIG. 8A, the increment in the driving voltage EL_DV for the light emitting element EL may increase as the luminance PL of the display panel 110 increases, and may also increase as the degradation amounts DA1, DA2, DA3 and DA4 of the display panel 110 increase. Further, in some embodiments, the driving voltage lookup table DV_LUT may store the driving voltage increments 310, 330 and 350 illustrated in FIG. 8A. For example, as illustrated in FIG. 8B, with respect to the luminance PL of the display panel 110 of about 200 nit, the driving voltage lookup table DV LUT may store about OV corresponding to no degradation, a first driving voltage increment DVI1 corresponding to a first degradation amount DA1, a second driving voltage increment DVI2 corresponding to a second degradation amount DA2, a third driving voltage increment DVI3 corresponding to a third degradation amount DA3 and a fourth driving voltage increment DVI4 corresponding to a fourth degradation amount DA4. Further, with respect to the luminance PL of the display panel 110 of about 400 nit, the driving voltage lookup table DV_LUT may store about 0 V corresponding to no degradation, a fifth driving voltage increment DVI5 corresponding to the first degradation amount DA1, a sixth driving voltage increment DVI6 corresponding to the second degradation amount DA2, a seventh driving voltage increment DVI7 corresponding to the third degradation amount DA3 and an eighth driving voltage increment DVI8 corresponding to the fourth degradation amount DA4. In addition, with respect to the luminance PL of the display panel 110 of about 500 nit, the driving voltage lookup table DV_LUT may store about 0 V corresponding to no degradation, a ninth driving voltage increment DVI9 corresponding to the first degradation amount DA1, a tenth driving voltage increment DVI10 corresponding to the second degradation amount DA2, an eleventh driving voltage increment DVI11 corresponding to the third degradation amount DA3 and a twelfth driving voltage increment DVI12 corresponding to the fourth degradation amount DA4.

Further, in some embodiments, the driving voltage determining block 178 may decrease the voltage level of the second power supply voltage ELVSS by the driving voltage increase that is determined using the driving voltage lookup table DV_LUT. In FIG. 9A, 410 represents the second power supply voltage ELVSS according to the degradation amounts DA1, DA2, DA3 and DA4 of the display panel 110 when the luminance PL of the display panel 110 is about 200 nit, 430 represents the second power supply voltage ELVSS according to the degradation amounts DA1, DA2, DA3 and DA4 of the display panel 110 when the luminance PL of the display panel 110 is about 400 nit, and 450 represents the second power supply voltage ELVSS according to the degradation amounts DA1, DA2, DA3 and DA4 of the display panel 110 when the luminance PL of the display panel 110 is about 500 nit. In a conventional display device, the second power supply voltage ELVSS may remain unchanged regardless of the degradation amounts DA1, DA2, DA3 and DA4 of the display panel 110. However, in the display device 100 according to embodiments, the voltage level of the second power supply voltage ELVSS may be reduced based on the luminance PL and the degradation amount DA1, DA2, DA3 and DA4 of the display panel 110. For example, as illustrated in FIGS. 9A and 9B, in a case where the luminance PL of the display panel 110 is about 200 nit, when the display panel 110 is degraded by the first degradation amount DA1, the driving voltage determining block 178 may obtain the first driving voltage increment DVI1 from the driving voltage lookup table DV_LUT, and may decrease the second power supply voltage ELVSS by the first driving voltage increment DVI1 from a first initial voltage level IVL1 corresponding to no degradation (i.e., IVL1-DVI1). Further, in the case where the luminance PL of the display panel 110 is about 200 nit, the driving voltage determining block 178 may decrease the second power supply voltage ELVSS by the second driving voltage increment DVI2 from the first initial voltage level IVL1 when the display panel 110 is degraded by the second degradation amount DA2 (i.e., IVL1-DVI2), may decrease the second power supply voltage ELVSS by the third driving voltage increment DVI3 from the first initial voltage level IVL1 when the display panel 110 is degraded by the third degradation amount DA3 (i.e., IVL1-DVI3), and may decrease the second power supply voltage ELVSS by the fourth driving voltage increment DVI4 from the first initial voltage level IVL1 when the display panel 110 is degraded by the fourth degradation amount DA4 (i.e., IVL1-DVI4). In addition, in a case where the luminance PL of the display panel 110 is about 400 nit, when the display panel 110 is degraded by the first degradation amount DA1, the driving voltage determining block 178 may obtain the fifth driving voltage increment DVI5 from the driving voltage lookup table DV_LUT, and may decrease the second power supply voltage ELVSS by the fifth driving voltage increment DVI5 from a second initial voltage level IVL2 corresponding to no degradation (i.e., IVL2-DVI5). Further, in the case where the luminance PL of the display panel 110 is about 400 nit, the driving voltage determining block 178 may decrease the second power supply voltage ELVSS by the sixth driving voltage increment DVI6 from the second initial voltage level IVL2 when the display panel 110 is degraded by the second degradation amount DA2 (i.e., IVL2-DVI6), may decrease the second power supply voltage ELVSS by the seventh driving voltage increment DVI7 from the second initial voltage level IVL2 when the display panel 110 is degraded by the third degradation amount DA3 (i.e., IVL2-DVI7), and may decrease the second power supply voltage ELVSS by the eighth driving voltage increment DVI8 from the second initial voltage level IVL2 when the display panel 110 is degraded by the fourth degradation amount DA4 (i.e., IVL2-DVI8). In addition, in a case where the luminance PL of the display panel 110 is about 500 nit, when the display panel 110 is degraded by the first degradation amount DA1, the driving voltage determining block 178 may obtain the ninth driving voltage increment DVI9 from the driving voltage lookup table DV_LUT, and may decrease the second power supply voltage ELVSS by the ninth driving voltage increment DVI9 from a third initial voltage level IVL3 corresponding to no degradation (i.e., IVL3-DVI9). Further, in the case where the luminance PL of the display panel 110 is about 500 nit, the driving voltage determining block 178 may decrease the second power supply voltage ELVSS by the tenth driving voltage increment DVI10 from the third initial voltage level IVL3 when the display panel 110 is degraded by the second degradation amount DA2 (i.e., IVL3-DVI10), may decrease the second power supply voltage ELVSS by the eleventh driving voltage increment DVI11 from the third initial voltage level IVL3 when the display panel 110 is degraded by the third degradation amount DA3 (i.e., IVL3-DVI11), and may decrease the second power supply voltage ELVSS by the twelfth driving voltage increment DVI12 from the third initial voltage level IVL3 when the display panel 110 is degraded by the fourth degradation amount DA4 (i.e., IVL3-DVI12). Accordingly, the reduction in luminance of the light emitting element EL caused by the increase in the driving voltage EL_DV for the light emitting element EL may be compensated by lowering the second power supply voltage ELVSS.

In other embodiments, the driving voltage determining block 178 may set the voltage level of the second power supply voltage ELVSS to a default voltage level when the driving voltage increment determined from the driving voltage lookup table DV_LUT is less than or equal to a reference voltage increment corresponding to the luminance PL of the display panel 110. If the determined driving voltage increment exceeds the reference voltage increment, the voltage level of the second power supply voltage ELVSS may be reduced by the amount of the determined driving voltage increment. In FIG. 10A, 415 represents the second power supply voltage ELVSS according to the degradation amounts DA1, DA2, DA3 and DA4 of the display panel 110 when the luminance PL of the display panel 110 is about 200 nit, 435 represents the second power supply voltage ELVSS according to the degradation amounts DA1, DA2, DA3 and DA4 of the display panel 110 when the luminance PL of the display panel 110 is about 400 nit, and 455 represents the second power supply voltage ELVSS according to the degradation amounts DA1, DA2, DA3 and DA4 of the display panel 110 when the luminance PL of the display panel 110 is about 500 nit. For example, as illustrated in FIGS. 10A and 10B, in the case where the luminance PL of the display panel 110 is about 200 nit, if the first driving voltage increment DVI1 obtained from the driving voltage lookup table DV_LUT is less than or equal to a first reference voltage increment, the driving voltage determining block 178 may set the second power supply voltage ELVSS to a first default voltage level DVL1 (e.g., lower than the first initial voltage level IVL1 illustrated in FIGS. 9A and 9B). Further, in the case where the luminance PL of the display panel 110 is about 200 nit, if each of the second, third and fourth driving voltage increments DVI2, DVI3 and DVI4 is greater than the first reference voltage increment, the driving voltage determining block 178 may set the second power supply voltage ELVSS to “IVL1-DVI2”, “IVL1-DVI3” and “IVL1-DVI4” at the second, third and fourth degradation amounts DA2, DA3 and DA4, respectively. In addition, in the case where the luminance PL of the display panel 110 is about 400 nit, if the fifth driving voltage increment DVI5 obtained from the driving voltage lookup table DV_LUT is lower than or equal to a second reference voltage increment, the driving voltage determining block 178 may set the second power supply voltage ELVSS to a second default voltage level DVL2 (e.g., lower than the second initial voltage level IVL2 illustrated in FIGS. 9A and 9B). Further, in the case where the luminance PL of the display panel 110 is about 400 nit, if each of the sixth, seventh and eighth driving voltage increments DVI6, DVI7 and DVI8 is greater than the second reference voltage increment, the driving voltage determining block 178 may set the second power supply voltage ELVSS as “IVL2-DVI6”, “IVL2-DVI7” and “IVL2-DVI8” to the second, third and fourth degradation amounts DA2, DA3 and DA4, respectively. In addition, in the case where the luminance PL of the display panel 110 is about 500 nit, if the ninth driving voltage increment DVI9 obtained from the driving voltage lookup table DV_LUT is lower than or equal to a third reference voltage increment, the driving voltage determining block 178 may set the second power supply voltage ELVSS to a third default voltage level DVL3 (e.g., lower than the third initial voltage level IVL3 illustrated in FIGS. 9A and 9B). Further, in the case where the luminance PL of the display panel 110 is about 500 nit, if each of the tenth, eleventh and twelfth driving voltage increments DVI10, DVI11 and DVI12 is greater than the third reference voltage increment, the driving voltage determining block 178 may set the second power supply voltage ELVSS to “IVL3-DVI10”, “IVL3-DVI11” and “IVL3-DVI12” at the second, third and fourth degradation amounts DA2, DA3 and DA4, respectively. Accordingly, the luminance decrease of the light emitting element EL caused by the increase in the driving voltage EL_DV for the light emitting element EL may be compensated by decreasing the second power supply voltage ELVSS. As described above, in the display device 100 according to embodiments, the reduction in

luminance of the light emitting element EL caused by its degradation may be compensated by adjusting the input image data IDAT based on the stress data SDAT. Additionally, the decrease in luminance of the light emitting element EL due to an increase in the driving voltage EL_DV may be compensated by lowering the second power supply voltage ELVSS.

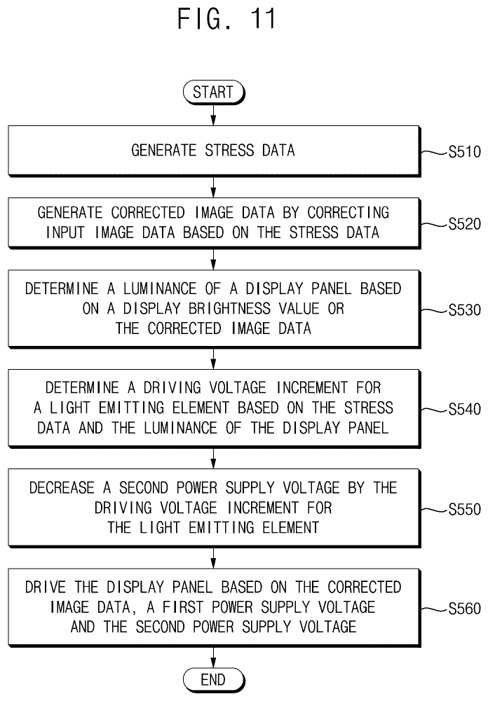

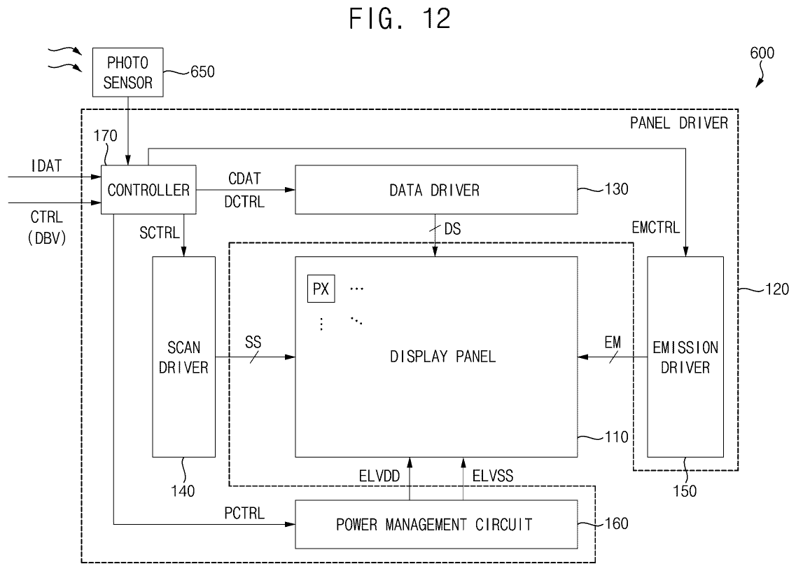

FIG. 11 is a flowchart illustrating a method of operating a display device according to embodiments.

Referring to FIGS. 1, 3 and 11, the degradation accumulating block 172 of the display device 100 may generate the stress data SDAT that represents the amount degradation of the display panel 110 based on the corrected image data CDAT (S510), and the degradation compensating block 174 of the display device 100 may generate the corrected image data CDAT by compensating the input image data IDAT based on the stress data SDAT (S520). In other words, the degradation compensating block 174 may generate the corrected image data CDAT by correcting the input image data IDAT based on the stress data SDAT.

The output image analyzing block 176 of the display device 100 may determine the luminance PL of the display panel 110 based on the display brightness value DBV or the corrected image data CDAT (S530), and the driving voltage determining block 178 of the display device 100 may change the second power supply voltage ELVSS based on the stress data SDAT and the luminance PL of the display panel 110 (S540 and S550). For example, the driving voltage determining block 178 may determine a driving voltage increment for the light emitting element based on the stress data SDAT and the luminance PL of the display panel 110 (S540), and decrease the second power supply voltage ELVSS by the driving voltage increment for the light emitting element (S550).

The panel driver 120 of the display device 100 may drive the display panel 110 based on the corrected image data CDAT, the first power supply voltage ELVDD and the changed second power supply voltage ELVSS (S570). Accordingly, in the display device 100 according to embodiments, the reduction in luminance due to the degradation of the light emitting element may be compensated by adjusting the input image data IDAT based on the stress data SDAT. Additionally, the reduction in luminance caused by an increase in the driving voltage for the light emitting element may be compensated by lowering the second power supply voltage ELVSS.

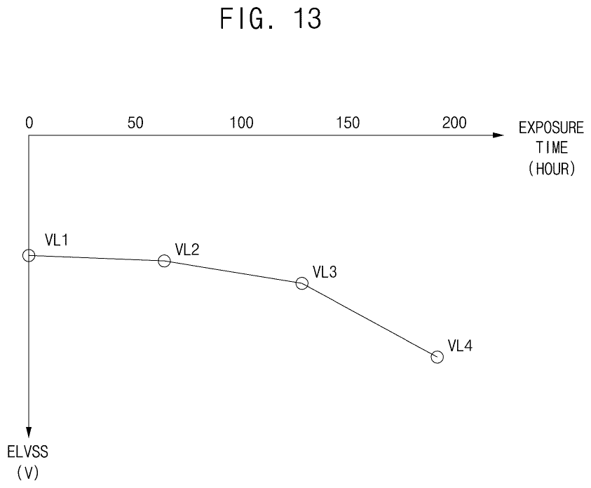

FIG. 12 is a block diagram illustrating a display device according to embodiments, and FIG. 13 is a diagram illustrating an example of a second power supply voltage according to an exposure time of external ultraviolet light.

Referring to FIG. 12, a display device 600 may include a display panel 110, a panel driver 120 and a photo sensor 650. The display device 600 of FIG. 12 may have substantially the same configuration and substantially the same operation as the display device 100 of FIG. 1, except that the display device 600 may further include the photo sensor 650.

The photo sensor 650 may detect external ultraviolet light (or external ultraviolet rays), and the panel driver 120 of the display device 600 may accumulate an exposure time during which the display panel 110 is exposed to the external ultraviolet light by using the photo sensor 650. Further, the panel driver 120 may adjust a second power supply voltage ELVSS not only based on the degradation amount and luminance of the display panel 110, but also according to the exposure time. In some embodiments, the panel driver 120 may decrease the second power supply voltage ELVSS as the exposure time increases. For example, as illustrated in FIG. 13, even if the degradation amount and the luminance of the display panel 110 do not change, the panel driver 120 may decrease the second power supply voltage ELVSS from a first voltage level VL1 to a second voltage level VL2 at the exposure time of about 64 hours. Further, the panel driver 120 may further decrease the second power supply voltage ELVSS to a third voltage level VL3 at the exposure time of about 128 hours, and may further decrease the second power supply voltage ELVSS to a fourth voltage level VL4 at the exposure time of about 192 hours.

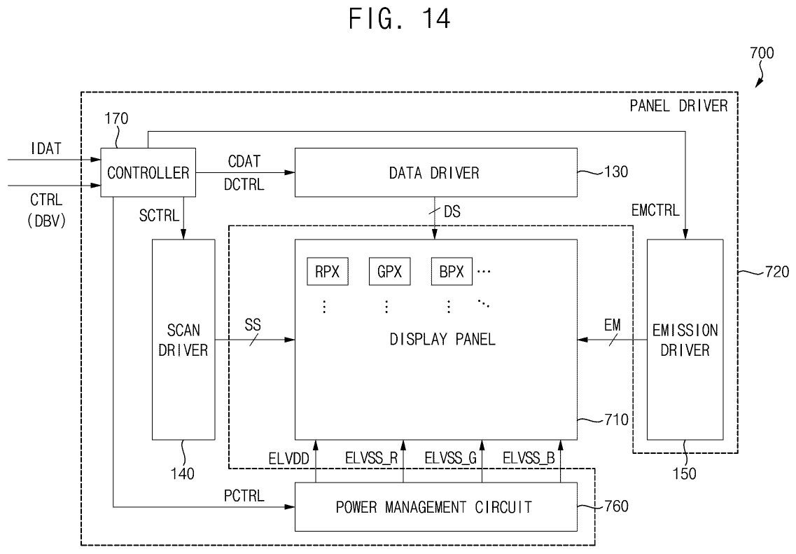

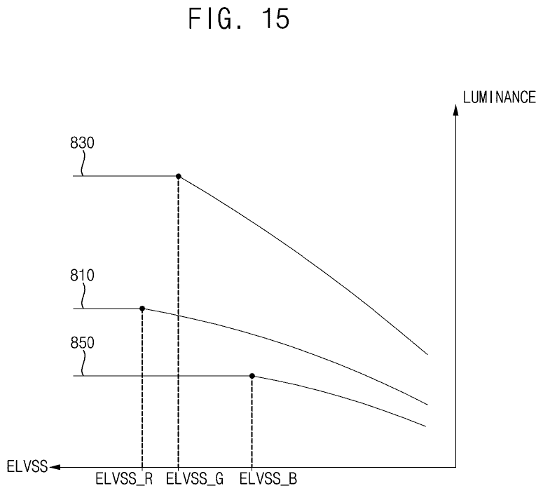

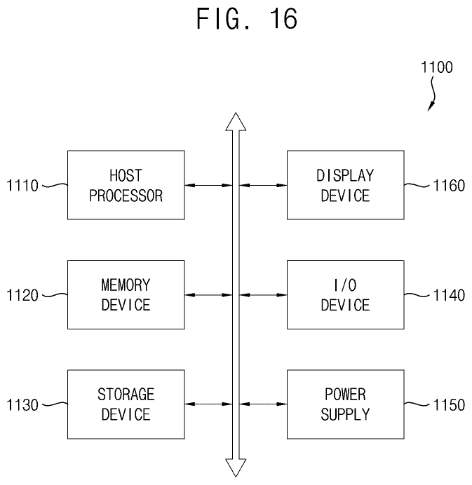

FIG. 14 is a block diagram illustrating a display device according to embodiments, and FIG. 15 is a diagram for describing an example of a second red power supply voltage, a second green power supply voltage and a second blue power supply voltage.

Referring to FIG. 14, a display device 700 may include a display panel 710 and a panel driver 720. The display device 700 of FIG. 14 may have substantially the same configuration and substantially the same operation as a display device 100 of FIG. 1, except that a power management circuit 760 may provide a second red power supply voltage ELVSS_R to red pixels RPX of the display panel 710, may provide a second green power supply voltage ELVSS_G to green pixels GPX of the display panel 710, and may provide a second blue power supply voltage ELVSS_B to blue pixels BPX of the display panel 710.

The display panel 710 may include the red pixels RPX, the green pixels GPX and the blue pixels BPX, and the power management circuit 760 may provide the second red power supply voltage ELVSS_R to the red pixels RPX, the second green power supply voltage ELVSS_G to the green pixels GPX, and the second blue power supply voltage ELVSS_B to the blue pixels BPX. In FIG. 15, 810 represents a luminance of the red pixels RPX according to a second power supply voltage ELVSS, 830 represents a luminance of the green pixels GPX according to the second power supply voltage ELVSS, and 850 represents a luminance of the blue pixels BPX according to the second power supply voltage ELVSS. As illustrated in FIG. 15, optimal voltage levels of the second power supply voltage ELVSS for the red, green and blue pixels RPX, GPX and BPX may be different from each other, and thus, the second red power supply voltage ELVSS_R for the red pixels RPX, the second green power supply voltage ELVSS_G for the green pixels GPX and the second blue power supply voltage ELVSS_B for the blue pixels BPX may be set to different voltage levels. For example, the second red power supply voltage ELVSS_R may be set to the lowest voltage level, the second blue power supply voltage ELVSS_B may be set to the highest voltage level, and the second green power supply voltage ELVSS_G may be set to a voltage level between the second red power supply voltage ELVSS_R and the second blue power supply voltage ELVSS_B. Further, the panel driver 720 may individually control the second red power supply voltage ELVSS_R, the second green power supply voltage ELVSS_G and the second blue power supply voltage ELVSS_B. In some embodiments, the panel driver 720 may change the second red power supply voltage ELVSS_R based on the stress data for the red pixels RPX and the luminance of the red pixels RPX, change the second green power supply voltage ELVSS_G based on the stress data for the green pixels GPX and the luminance of the green pixels GPX, and change the second blue power supply voltage ELVSS_B based on the stress data for the blue pixels BPX and the luminance of the blue pixels BPX.

FIG. 16 is a block diagram illustrating an electronic device including a display device according to embodiments.

Referring to FIG. 16, an electronic device 1100 may include a processor 1110 (e.g., a host processor), a memory device 1120, a storage device 1130, an input/output (I/O) device 1140, a power supply 1150 and a display device 1160. The electronic device 1100 may further include a plurality of ports for communicating with a video card, a sound card, a memory card, a universal serial bus (USB) device, other electric devices, etc.

The processor 1110 may perform various computing functions or tasks. The processor 1110 may be an application processor (AP), a micro-processor, a central processing unit (CPU), etc. The processor 1110 may be coupled to other components via an address bus, a control bus, a data bus, etc. Further, in some embodiments, the processor 1110 may be further coupled to an extended bus such as a peripheral component interconnection (PCI) bus.

The memory device 1120 may store data for operations of the electronic device 1100. For example, the memory device 1120 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile DRAM device, etc.

The storage device 1130 may be a solid state drive (SSD) device, a hard disk drive (HDD) device, a CD-ROM device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

In the display device 1160, corrected image data may be generated by adjusting input image data based on stress data, and a display panel may be driven using the corrected image data. This allows compensation for luminance reduction caused by degradation of a light emitting element. Further, in the display device 1160, the luminance of the display panel may be determined based on at least one of a display brightness value and the corrected image data, and a second power supply voltage (e.g., a low power supply voltage) may be adjusted based on the stress data and the luminance of the display panel. Accordingly, the power consumption of the display device 1160 may be reduced, and the luminance reduction caused by an increase in driving voltage for the light emitting element may be compensated.

The inventive concept may be applied any electronic device 1100 including the display device 1160. For example, the inventive concept may be applied to a television (TV) (e.g., a digital TV, a three-dimensional (3D) TV, etc.), a smart phone, a mobile phone, a personal computer (PC) (e.g., a tablet computer, a laptop computer, etc.), a wearable electronic device, a home appliance, a personal digital assistant (PDA), a portable multimedia player (PMP), a digital camera, a music player, a portable game console, a navigation device, etc.

The foregoing is intended to illustrate various embodiments of the present inventive concept and should not be construed as limiting. Although a few embodiments have been described, those skilled in the art will recognize that many modifications can be made without departing from the novel teachings of the present inventive concept. Accordingly, all such modifications are intended to be included within the scope of the present inventive concept as set forth in the claims.

What is claimed is:

1. A display device comprising:
a display panel including a plurality of pixels; and
a panel driver connected to the display panel, the panel driver configured to generate stress data representing a degradation amount of the display panel, to generate corrected image data by adjusting input image data based on the stress data, to determine a luminance of the display panel based on a display brightness value or the corrected image data, to adjust a second power supply voltage based on the stress data and the luminance of the display panel, and to drive the display panel based on the corrected image data, a first power supply voltage and the second power supply voltage.

2. The display device of claim 1, wherein the first power supply voltage is a high power supply voltage,
wherein the second power supply voltage is a low power supply voltage, and
wherein the panel driver decreases the low power supply voltage based on the stress data and the luminance of the display panel.

3. The display device of claim 1, wherein each of the plurality of pixels includes a light emitting element, and
wherein the panel driver is configured to determine a driving voltage increment for the light emitting element based on the stress data and the luminance of the display panel, and to decrease the second power supply voltage by the driving voltage increment for the light emitting element.

4. The display device of claim 1, wherein the panel driver is configured to compensate for a luminance decrease of light emitting elements of the plurality of pixels by adjusting the input image data based on the stress data, or adjusting the second power supply voltage.

5. The display device of claim 1, wherein the panel driver includes:
a scan driver configured to provide scan signals to the plurality of pixels;
a data driver configured to provide data signals to the plurality of pixels based on the corrected image data;
a power management circuit configured to provide the first power supply voltage and the second power supply voltage to the plurality of pixels; and
a controller configured to control the scan driver, the data driver and the power management circuit, and to provide a power control signal to the power management circuit to adjust the second power supply voltage.

6. The display device of claim 5, wherein the controller includes:
a degradation accumulating circuit configured to generate the stress data based on the corrected image data;
a degradation compensating circuit configured to generate the corrected image data by adjusting the input image data based on the stress data;
an output image analyzing circuit configured to determine the luminance of the display panel based on the display brightness value and the corrected image data; and
a driving voltage determining circuit configured to determine a voltage level of the second power supply voltage based on the stress data and the luminance of the display panel, and to provide the power control signal, which represents the determined voltage level of the second power supply voltage, to the power management circuit.

7. The display device of claim 6, wherein the degradation accumulating circuit generates the stress data by accumulating the corrected image data.

8. The display device of claim 6, wherein, when the stress data indicates a first degradation amount for a first pixel among the plurality of pixels, and indicates a second degradation amount, which is greater than the first degradation amount, for a second pixel among the plurality of pixels, the degradation compensating circuit generates the corrected image data by increasing a gray level of the input image data for the second pixel.

9. The display device of claim 6, wherein, when the stress data indicates a first degradation amount for a first pixel among the plurality of pixels, and indicates a second degradation amount, which is greater than the first degradation amount, for a second pixel among the plurality of pixels, the degradation compensating circuit generates the corrected image data by decreasing a gray level of the input image data for the first pixel.

10. The display device of claim 6, wherein the luminance of the display panel determined by the output image analyzing circuit increases as the display brightness value increases, and increases as a gray level indicated by the corrected image data increases.

11. The display device of claim 6, wherein the output image analyzing circuit includes:
a luminance lookup table configured to store luminance values corresponding to gray levels indicated by the corrected image data for each of a plurality of display brightness values, and
wherein the output image analyzing circuit determines luminances of the plurality of pixels by using the luminance lookup table, and selects, a maximum luminance of the plurality of pixels as the luminance of the display panel.

12. The display device of claim 6, wherein the output image analyzing circuit includes:
a luminance lookup table configured to store luminance values corresponding to gray levels indicated by the corrected image data for each of a plurality of display brightness values, and
wherein the output image analyzing circuit determines luminances of the plurality of pixels by using the luminance lookup table, and selects, an average luminance of the plurality of pixels as the luminance of the display panel.

13. The display device of claim 6, wherein the voltage level of the second power supply voltage determined by the driving voltage determining circuit decreases as the degradation amount indicated by the stress data increases, and decreases as the luminance of the display panel increases.

14. The display device of claim 6, wherein the driving voltage determining circuit includes:
a driving voltage lookup table configured to store a plurality of driving voltage increments corresponding to a plurality of degradation amounts and a plurality of luminances, and
wherein the driving voltage determining circuit determines a driving voltage increment corresponding to the stress data and the luminance of the display panel by using the driving voltage lookup table, and sets the voltage level of the second power supply voltage based on the determined driving voltage increment.

15. The display device of claim 14, wherein, when the determined driving voltage increment is less than or equal to a reference voltage increment corresponding to the luminance of the display panel, the driving voltage determining circuit sets the voltage level of the second power supply voltage to a default voltage level, and
wherein, when the determined driving voltage increment is greater than the reference voltage increment, the driving voltage determining circuit decreases the voltage level of the second power supply voltage by the determined driving voltage increment.

16. The display device of claim 1, further comprising:
a photo sensor configured to detect external ultraviolet light,
wherein the panel driver accumulates an exposure time during which the display panel is exposed to the external ultraviolet light by using the photo sensor, and further adjusts the second power supply voltage based on the exposure time.

17. The display device of claim 16, wherein the panel driver decreases the second power supply voltage as the exposure time increases.

18. The display device of claim 1, wherein the plurality of pixels includes red pixels, green pixels and blue pixels,
wherein the second power supply voltage includes a second red power supply voltage to be applied to the red pixels, a second green power supply voltage to be applied to the green pixels, and a second blue power supply voltage to be applied to the blue pixels, and
wherein the panel driver adjusts the second red power supply voltage based on stress data for the red pixels and a luminance of the red pixels, adjusts the second green power supply voltage based on stress data for the green pixels and a luminance of the green pixels, and adjusts the second blue power supply voltage based on stress data for the blue pixels and a luminance of the blue pixels.

19. A method of operating a display device, the method comprising:
generating stress data that represents a degradation amount for a display panel of the display device;
generating corrected image data by adjusting input image data based on the stress data;
determining a luminance of the display panel based on a display brightness value or the corrected image data;
adjusting a second power supply voltage based on the stress data and the luminance of the display panel; and
driving the display panel based on the corrected image data, a first power supply voltage and the second power supply voltage.

20. The method of claim 19, wherein adjusting the second power supply voltage includes:
determining a driving voltage increment for a light emitting element based on the stress data and the luminance of the display panel; and
decreasing the second power supply voltage by the driving voltage increment for the light emitting element.
